(19) United States
(12) Patent Application Publication
(10) Pub. No.: US 2019/0366576 A1
(43) Pub. Date: Dec. 5, 2019

(54) Equipment for cutting polystyrene blocks in an automated way

(71) Applicant: Nettuno Sistemi di Ascone Salvatore & C. S.a.s., San Ferdinando (RC) (IT)

(72) Inventor: Salvatore Ascone, Rosarno (RC) (IT)

(21) Appl. No.: 16/470,592

(22) PCT Filed: Dec. 27, 2016
(86) PCT No.: PCT/IT2016/000308

§ 371 Date: Jun. 18, 2019

(51) Int. Cl. B26F 3/12

(52) U.S. Cl. CPC B26F 3/12

(57) ABSTRACT

An assembly for cutting a polystyrene block includes a lever element, adapted to be coupled to a hot cutting element, and a control device connected thereto. The lever is arranged so that a potential inclination of the hot cutting element can be followed during the feed motion of the cut, the lever further cooperating with a sensor set to detect a potential inclination deviation of the lever during the cut, in relation to an initial reference inclination, the control device being set to vary feed motion speed depending on the detected variation of inclination.

### TECHNICAL FIELD

The present invention refers to the technical field of equipment for cutting polystyrene.

In particular, the invention refers to an innovative equipment allowing to make cuts, according to preset geometries, that prove to be particularly precise, thus minimizing errors and waste.

### BACKGROUND ART

Machineries for cutting polystyrene blocks to obtain specific forms have been known for a long time.

Polystyrene cut, starting generally from initial blocks, allows to obtain products with various geometries, used in many fields, for example interior design, art and buildings.

Polystyrene cut is generally made by a metal wire which is heated to predetermined temperature through the passage of electric current, thus taking advantage of a restistive effect, named Joule effect.

Each wire is linked at its end to two sliders that are mobile towards one or more directions, for example along a horizontal and vertical axe or following curved or diagonal paths.

Therefore, sliders move monitored by a control device (generally a programmable PC or a PLC) according to a determined path. The control device, through a suitable program, allows to insert the initial references, cut geometries and measures and therefore activates and controls engines in such a so as to obtain the programmed cut. Therefore, the initial block is cut into predetermined desired shapes.

Many types of machineries exist, each one is specific for particular cuts, also by using more parallel wires.

In this way, eventually by more working cycles, it is possible to shape the block, also according to particularly complex geometries.

After this introduction, a remarkable technical inconvenience occurs over the prior art, thus frequently invalidating the quality of the end product, even with the risk of product waste.

The wire temperature and the feed speed are two variables to be necessarily coordinated, for obtaining the end product quality.

In fact, a non-optimal temperature, for example a little bit lower than required, would need a slower feed motion, for allowing a correct cut by the wire. If it does not take place, a progressive banding of the wire may occur with an inaccurate cut, as its feed motion is too rapid in respect to the melting speed of the material. On the contrary, a too warm wire with a too slow feed motion causes an excessive local melting of polystyrene with an irregular cut, leading to product waste.

Therefore, the ideal cutting temperature and the feed motion speed are parameters connected with each other and, in turn, they are conditioned by further typical causes of the piece to be cut and by environmental conditions. In particular, polystyrene hardness (Kg/m\hat{ }3), polystyrene production, its aging and its purity are causes that make each piece different from the other one. In that sense, it is not possible to standardize overall speed and temperature values, as each piece can have hardness and/or impurities that requires modifications of such parameters. In addition, also environmental parameters such as surrounding temperature and humidity can vary time after time the behavior of the piece to be processed.

Precisely because of this problem, the method is the setting of a certain standard temperature and of the machinery with a speed, known as statistically optimal for that type of processed block. Obviously, as said above, such process is very rudimentary and leads to approximate results. Moreover, the inaccuracy of set parameters arises during the cut, thus leading inevitably to qualitative waste of such product and compelling the operator to select another one, hoping that, as a consequence, parameters result better set than the previous case.

Everything said above causes a high amount of waste and a huge waste of working time.

### DISCLOSURE OF THE INVENTION

It is therefore the aim of the present invention to provide a device for cutting polystyrene which solves said technical inconveniences.

In particular, it is the aim of the present invention to provide a device allowing to cut polystyrene blocks precisely, according to preset geometries, thus minimizing waste and necessary time.

These and other aims are therefore obtained through the present device for cutting a polystyrene block (100) by a feed of a hot wire to a predetermined speed (V), according to claim 1.

Such device (20, 200) comprises means (M, S; 250, 230) configured for detecting an inclination of the wire during the cut such that a potential inclination deviation in respect to an inclination reference can be detected and to vary the motion speed (V) depending on the detected variation of inclination.

In this way, simply detecting the wire inclination, it is possible to evaluate conveniently how to vary the speed so as to bring back the wire to the rectilinear condition wherein the cut is correct.

In a possible embodiment, advantageously, such means comprise at least a lever element (21; 210) to which at least a hot cutting element (2) can be applied.

The lever element is preferably assembled on suitable motorized supports, moving it according to foreseen cutting direction.

According to the invention, the lever element (21; 210) is arranged in such a manner that it can follows, in use, a potential inclination of the cutting element (2), during the feed motion of the cut.

The wire inclination, that is its bending, shows a too high motion speed condition.

Therefore, it is enough to detect said inclination to correct the speed, thus reducing it conveniently.

For that purpose, the lever element (21; 210) is further cooperative with a sensor (M, S; 250, 230) which is able to detect one or more parameters indicating or attributable an inclination of the lever element (21; 210) during the cut.

In this way, it is enough to have a control device (CL) (for example, also a preexisting one of a previous machinery) and to set it in such a manner so as to detect a potential variation of inclination in respect to a reference inclination and, consequently, vary the motion speed (V) of the lever element depending on said detected variation of inclination.

In this way, it is possible to work precisely by maintaining a permanent temperature and acting on the speed only depending on the “local” condition of the cut.

Advantageously, it is therefore foreseen said control device (CL) connected to the sensor and set for calculating the parameter/s detected by the sensor, indicating the inclination of the lever element during the cut and varying said speed consequently.

Advantageously, the speed is varied in such a manner that the lever element (21; 210) is brought back to said reference condition.

Advantageously, the control device is set in such a manner so as to reduce the speed until it eliminates such detected deviation.

Advantageously, the control device is set in such a manner so as to vary the speed cyclically by increasing it, once such cancelling condition of the deviation has been reached, and by reducing it again when it detects a deviation.

In this way, the cut is accelerated and, contemporaneously, the condition wherein the wire motion is too slow in respect to the preset temperature is avoided, as this condition creates an excessive local melting.

Advantageously, said lever element (21, 210) is constrained to a support in such a manner so as to take at least a direction of inclination in respect to the constraint point (C; 220).

In particular, advantageously, said lever element is hinged.

Advantageously, said sensor is a HALL sensor.

As alternative, advantageously, said sensor is an infrared sensor or ultrasonic one.

Advantageously, such device can be integrated on a pre-existent machinery for cutting polystyrene.

Therefore, the device can be integrated on pre-existent machineries provided with their own control device which can be set as required.

As alternative, an assembly can be foreseen, with its own control device, to be installed always on pre-existent machineries or a machine built with such assembly can be foreseen.

For that purpose, it is therefore foreseen also an assembly for cutting a polystyrene block (100) by the motion of a hot wire cutter to a predetermined speed (V) and characterized in that it comprises means (CL, M, S; 250, 230) configured for detecting an inclination of the wire during the cut and control device (CL)

The control device checks a potential bending variation in respect to the reference condition and varying the motion speed (V) depending on said detected variation of inclination.

Advantageously, it is foreseen at least a lever element (21, 210) (21; 210) to which at least a hot cutting element (2) can be applied and with the control device (CL) communicating with said device (20, 200). The lever element (21, 210) is arranged in such a manner that it can follow in use a potential inclination of the cutting element (2), during the feed motion of the cut, said lever element (21; 210) being further cooperative with a sensor (M, S; 250, 230) indicating an inclination of the lever element (21; 210) while cutting, the control device (CL) being set to check said potential variation of inclination in respect to a reference inclination and to vary the motion speed (V) of the lever element depending on said detected variation of inclination.

Advantageously, the control device is programmed to vary the speed in such a manner so as to bring back the lever element (21; 210) to said reference condition.

Advantageously, such lever element in hinged.

Advantageously, said sensor is a HALL sensor, or, as alternative, it can be an infrared sensor or ultrasonic one.

Advantageously, the control device is programmed in such a manner so as to reduce the speed until it eliminates such detected deviation.

Advantageously, the control device is programmed in such a manner so as to vary the speed cyclically by increasing it, once such cancelling condition of the deviation has been reached, and by reducing it again when it detects a deviation.

It is also described here a machinery for cutting polystyrene comprising an assembly as described or a device as described.

It is also here described a method for cutting a polystyrene block (100), the method foreseeing the arrangement of a device (20, 200) having at least a lever element (21; 210) to which at least a hot cutting element (2) can be applied and the arrangement of a control device (CL), said lever element (21; 210) being arranged in such a manner that a potential inclination of the cutting element (2) can be detected in use, during the feed motion of the cut, such lever element (21; 210) being further cooperative with a sensor (M, S; 250, 230) indicating an inclination of the lever element (21; 210) while cutting, the method foreseeing the detection of the inclination of the lever element (21, 210) and the check by the control device (CL) of a potential variation of inclination in respect to a reference inclination and the consequent variation (V) of the motion feed of the lever element depending on said detected speed variation.

Advantageously, the speed is varied in such a manner so as to bring back the support to said initial reference condition.

Advantageously, the speed is varied in such a manner so as to vary the speed cyclically by increasing it, once such cancelling condition of the deviation has been reached, and by reducing it again when the deviation is detected.

### BRIEF DESCRIPTION OF DRAWINGS

Further features and advantages of the present ladder, according to the invention, will result to be clearer with the description that follows of some embodiments, made to illustrate but not to limit, with reference to the attached drawings, wherein:

FIG. 1 shows in axonometric view an outline of a polystyrene block 100 which has to be cut according to a predetermined geometry with a hot wire 2;

FIG. 2 shows a hypothetical cutting phase wherein the wire 2 bends in respect to the perfect linearity direction 10 of the wire. Whatever cutting direction can obviously be used, even diagonal.

FIGS. 3 and 4 represent schematically a solution with the use of a HALL sensor;

FIG. 5 resumes schematically the operation;

FIG. 6 is an overall flowchart of operation;

FIG. 7 is a trend of the feed motion speed according to the present method;

FIG. 8 shows schematically a type of alternative sensor which can be used in place of the HALL sensor.

### DESCRIPTION OF SOME PREFERRED EMBODIMENTS

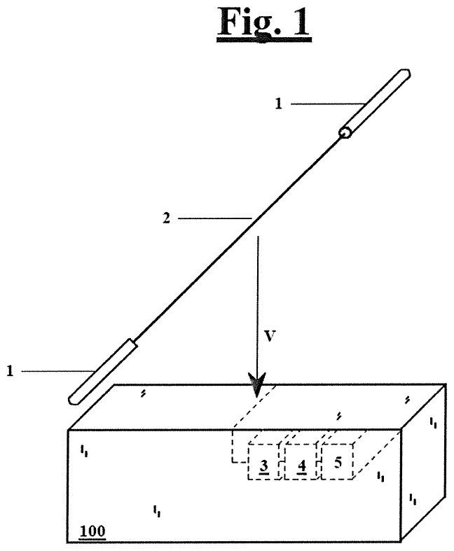

With reference to FIG. 1, a wire 2 is represented schematically for cutting polystyrene and it is liked at its ends with two sliders 1. The figure represents schematically a block 100 which, as example, is cut by the wire 2 in such a manner so as to obtain a series of tubulars with square section (3, 4, 5).

Therefore, the wire follows a cutting path represented by the dashed line and which foresees a vertical section, a second horizontal section and then the realization of tubulars placed side by side with a sequence of horizontal and vertical motions.

Obviously, this cutting type is only an example of many possible cutting type, as, depending on geometries, the motion of the wire 2 can also have different directions, such as diagonal and/or curved ones.

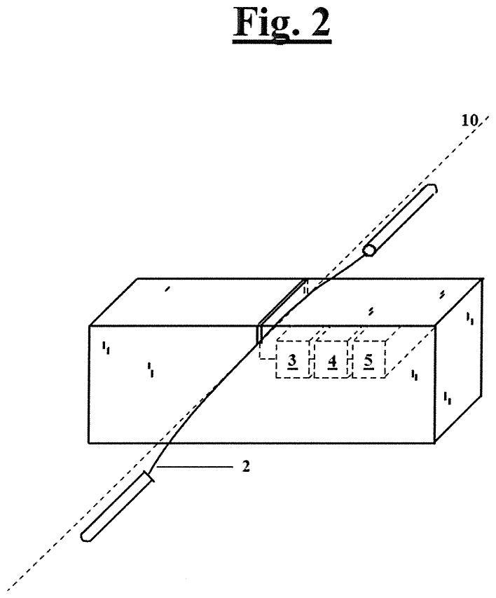

As shown schematically in FIG. 2, the feed motion speed can may be too high during the cut, due to the kind of block to be cut, thus leading to a wire bending. In fact, FIG. 2 shows schematically an ideal and perfectly rectilinear direction 10 of wire compared to the real curved trend (that is the bending) of the wire during the cut of this particular case.

In order to solve said technical inconvenience, a solution is proposed foreseeing the use of a sensor device (20, CL) able to detect an alignment variation (that is inflected wire) in respect to a reference condition represented by the linearity condition of the wire (that is non-curved wire).

Substantially, the system detects a bending deviation of the wire in respect to a reference linear condition.

At this point, a correlation between the feed motion speed and its detected alignment deviation is created so as that a speed variation is generated depending on such deviation.

More particularly, as soon as a wire bending is detected, a speed reduction takes place, thus annulling such bending and therefore the wire is brought back to an aligned condition, that is the initial reference condition. Obviously, as explained below, such speed variation is not accidental but is a function of the detected bending.

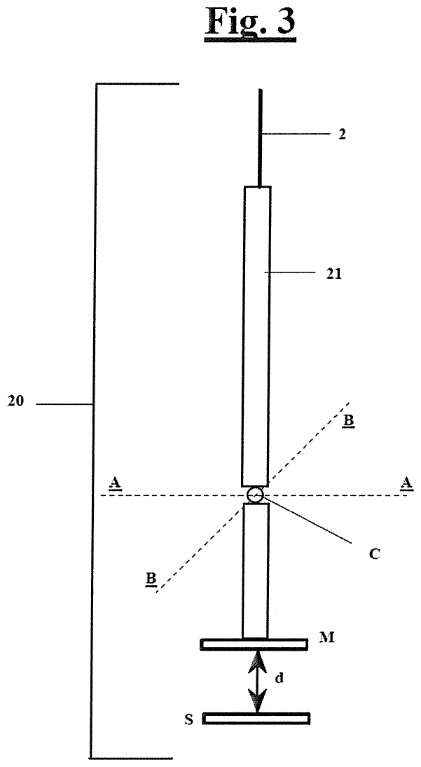

FIG. 3 outlines such kind of solution structurally, by outlining as a whole the device 20 foreseeing a sensor.

The further described device 20 may be an element which can be mounted on pre-existing cutting machineries (that is equipped with feed motion engine, control device, etc.) or a cutting machine can be built including such integrated device.

As outlined in FIG. 3, a lever element 21 is foreseen, to which a wire 2 can be connected for cutting.

The lever element is equipped with a sensor (M, S).

A HALL sensor can be particularly suitable, as it is particularly precise and sensitive.

The sensor can be of the two-axis type (A-A; B-B) or three or more axis depending on needs.

The following internet address gives an example of a description of a usable HALL sensor; it is produced by the factory MELEXIS and the sensor is commercially named “Triaxis”.

http://www.mlxsemi.com/Position--Speed-Sensors/Triaxis®-Hall-ICs/Triaxis-760.aspx

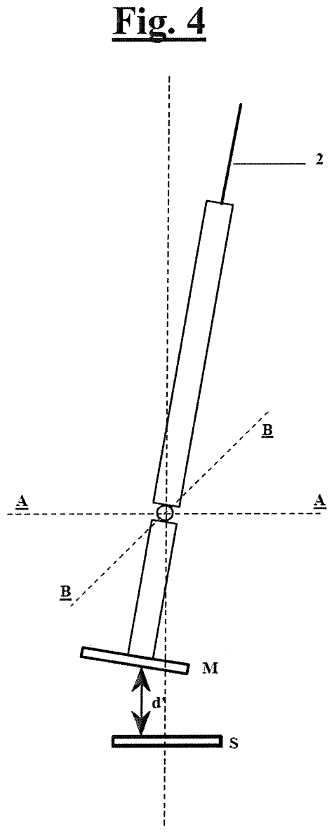

This kind of sensor, as outlined in FIGS. 3 and 4, foresees a magnet M which generates a magnetic field and an element S sensitive to such magnetic field. Such element S is able to detect a variation of the magnetic field when and whether the magnet modifies its position.

Therefore, the lever element 21 is hinged to a point (C) on a rigid support, thus forming a support structure (obviously, the whole element is transportable and mountable on pre-existing machineries).

FIG. 3 shows the two axis A-A and B-B around where, for example, such lever 21 can rotate even if, obviously, the axis may be different both for number and for direction.

The HALL sensor is foreseen to the opposite side of the hinging, to the opposite side to the application point of wire 2. Therefore, the figure shows the magnet M and the sensor S below, receiving the magnetic field and its variations.

As per FIG. 3, during the cut, when the wire keeps a rectilinear direction in axis with the lever 21, then the magnet keeps a certain distance (d) in respect to the sensor S and the sensor detects a certain value of the magnetic field which is considered as reference value.

As per FIG. 4, as the wire bends, then the lever follows the wire inclination, thanks to the hinging, thus modifying the distance between the magnet M and the sensor S, so as that the sensor detects such magnetic field variation in respect to the reference condition.

It is therefore possible, through the control device (CL), to elaborate measures detected by the sensor, in order to check if there is a variation in respect to the reference condition and to vary the motion speed depending on such inclination variation in respect to an initial reference condition (therefore, to modify the speed depending on magnetic field variation detected by the element S in function of a magnetic field condition, considered as initial reference).

Therefore, as the wire moves forward too quickly in respect to the set temperature and/or in respect to the type of block to be cut and/or environmental conditions, then the wire bends and such angle variation, in respect to the rectilinear condition, is immediately detected by the element S in terms of magnetic field variation in respect to the reference condition, as the lever 21 indeed has bent, thus dragging the magnet M.

A preset quantification of such field variation, detected by the sensor, can be easily linked to a certain percentage of necessary speed reduction.

The mathematical law which links a field variation, detected by the sensor S, to the necessary speed reduction can be for example of the linear type such that a line of progressive deceleration can be easily created as function of an increase of magnetic field deviation. Substantially, a certain deceleration can be associated for each of the detected magnetic field change delta.

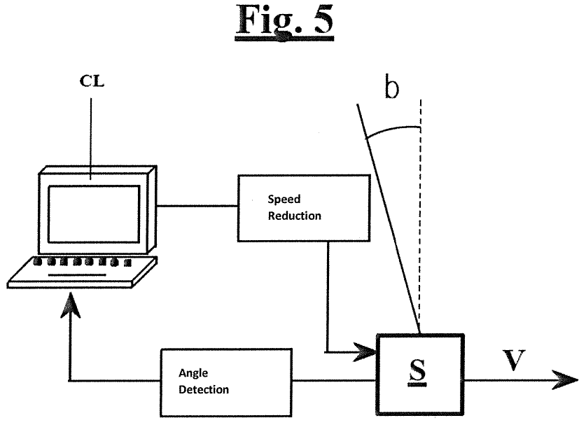

Therefore, as schematically shown in FIG. 5, the assembly which foresees a slider provided with the sensor connected to it, is linked to the control device (CL), such as a PC or also programmable PC computers.

Minute by minute, during the cutting phase, the element S measures the detected field and sends the detected survey to the control device (CN). The control device checks if there is a field variation in respect to the set reference value and orders a consequent speed reduction if it finds a variation (reduction connected to the set mathematical law depending on the detected variation value). Therefore, such speed reduction can be proportional to the detected variation, so as to tend to progressively bring the wire in a condition of linearity, gradually that the speed is reduced.

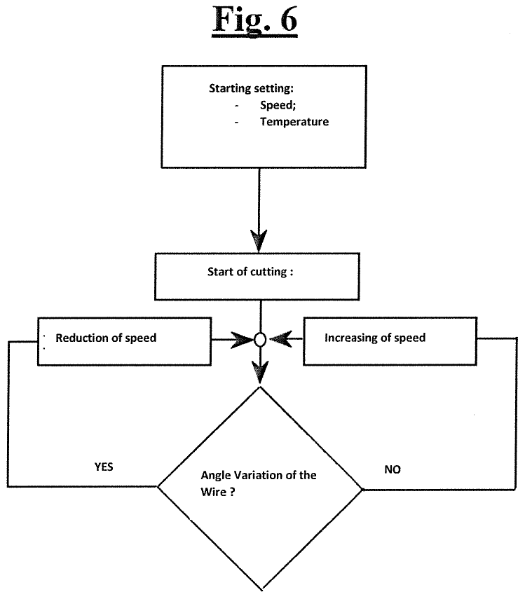

More particularly, the flowchart of FIG. 6 better explains the cutting operation.

The cutting temperature is kept regular in traditional way and it is not varied and it is generally set to a value immediately below the melting one or breaking one of the used wire, in such a manner so as to take advantage of the maximum feed motion speed.

In case of too slow feed motion in respect to the piece to be cut and to the set temperature, the wire does not bend and remains perfectly aligned but an excessive combustion takes place locally and this event cannot be detected, as the sensor does not detect any angle variation of the wire.

To avoid this inconvenience, the cutting method foresees also a setting of an extremely high initial speed for any kind of polystyrene to be cut. For example, the speed may be 2.200 mm per minute, considering that, on average, the cutting speed is approximately 600 or 700 mm per minute, or even less.

Substantially, the initial condition foresees the maximum tolerable temperature for the hot wire and the maximum achievable speed.

As soon as the cutting begins, the wire, which moves towards the block, bends as soon as it meets the piece, due to the initial high speed. The sensor, within the necessary responsiveness time, immediately detects a high field variation and the control device, once verified the field variation in respect to the reference field value which represents the linearity condition of the wire, elaborates such difference in respect to the initial reference condition and orders a drastic speed reduction which leads the slider nearly to stop.

Anyway, the wire bending and its temperature are sufficient (for the effect of elastic returns of the wire) to keep cutting because of inertia, until the wire is in a perfectly linear condition, with a consequent return of the field value within the set reference value.

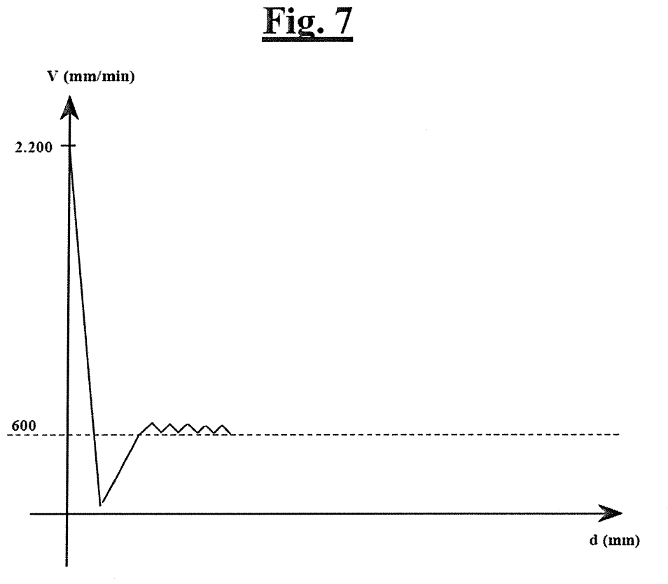

The flowchart of FIG. 7 shows, with the first descending part, the initial cutting phase, where a sudden speed reduction almost to zero takes place until the wire is in a linear condition.

The system is set in such a manner that each linearity condition of the wire is followed by a progressive speed increase. This is for guaranteeing not only the maximum efficiency, but also and specially to prevent the wire from cutting too slowly in respect to the set condition.

In this sense, therefore, the slider starts to move with a progressively increasing speed, until it reaches its ideal equilibrium condition represented by the horizontal line, set to the 600 mm/min value, as example.

At this point, in the preferred cutting way, such speed is not kept unvaried (even if it is practicable) but it is preferred to continue varying such speed minute by minute. In particular, at the moment when the condition of an aligned wire (600 mm/min in the example of FIG. 7), the control device continues to order a progressive acceleration, therefore a speed increase, until when a slight axis variation of the wire is caused with a consequent new speed reduction for bringing back the wire in axis. The whole process takes place uninterruptedly during the cut minute by minute. The result is that, as a whole, as average, the optimal speed is as it is kept unvaried, but, actually, such sight variations create oscillations around an equilibrium speed and make the system adapt best to the “local” cutting condition which is operating, thus avoiding the risk of a “locally” low cutting speed with a consequent cutting defect.

Therefore, in this way, by maintaining the unvaried temperature and starting from a high initial cutting speed, the system adapts itself automatically the cutting speed minute by minute, depending on local conditions of the area to be cut.

In this particularly simply manner, a precise cut is achieved, thus correcting well imperfections due to environmental causes and typical features of polystyrene.

In a variation, by starting from a high cutting speed as already said, nothing could prevent the wire from keeping the reached speed unvaried during the cutting operation, potentially reducing it when an angle variation is detected, even if, in this case, the inconvenience of not preventing a too high temperature of wire can take place in the specific cutting point (such condition that vary locally within the same block to be cut, as already said).

Considering what has been described above, obviously, other types of sensors able to detect an inclination variation of the wire during the cut may be used in any case.

For example, infrared sensors, ultrasound sensors or laser sensor.

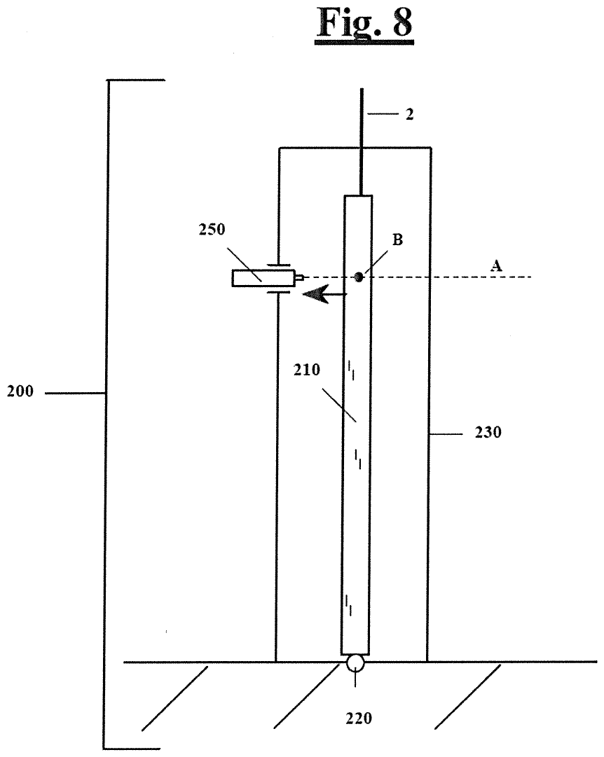

An example is shown in FIG. 8.

Such figure shows an example of solution 200 with an ultrasound sensor or a laser one.

In this case, the lever element 210 is hinged to one of its end (through a hinge 220) within a tubular duct 230, prearranged fixed in a support.

The external tubular foresees two holes in axis at 90° angles and in which are arranged two ultrasonic emitters 250 that project respectively on two orthogonal axes (A-B). The axis B is shown exiting from the drawing surface.

Ultrasounds intercept the lever element 210 and are reflected backwards. The return period allows to calculate the potential position in axis of the lever element. In particular, exactly like the previous case, the processor elaborates returning data and check if there is a position in axis or a misalignment in respect to the reference condition.

Therefore, in this way, any misalignment is detectable, approaching or distancing the lever element from the respective emitters and therefore, a variation from a reference condition which represents the lever element in axis indeed.

In function of the detected variations, the control device reduces the speed proportionally.

As already said above, in all embodiments, such device can be separated from any machinery and thus assembled also on pre-existing machineries.

The device which connects to the control device (for example the PC) and is programmed to receive from the sensor the detected data and regulate consequently the feed motion speed.

Obviously, machineries with such integrated system can be foreseen.

Considering what has been described above, a further embodiment may foresee a detection of the wire inclination during the cut, for example through a camera system or through a laser sensor which detects the wire and, therefore, without necessarily taking advantage of the system of lever inclination following the wire but instead by prearranging it unmovably. This solution, even achievable, is more constructively complex and therefore less precise.

The invention claimed is:

1. A device (20, 200) for cutting a polystyrene block (100) by feeding a hot wire at a predetermined motion speed (V), comprising:
means (M, S; 250, 230) configured to detect a bend of the hot wire during the cutting so that a potential bending variation can be verified in respect to a reference condition and the motion speed (V) varied depending on a detected bending variation.

2. The device (20, 200) as per claim 1, further comprising a control device (CL) configured to check said potential bending variation in respect to the reference condition and vary the motion speed (V) depending on the detected bending variation.

3. The device, as per claim 1, further comprising:
a lever (21; 210), adapted to be operatively coupled to the hot wire;
said lever (21; 210) being arranged to follow, in use, a potential inclination of the hot wire during a feed motion of the cutting, said lever (21; 210) being further cooperative with a sensor (M, S; 250, 230) indicating an inclination of the lever (21; 210) during the cutting, in such a manner that a control device (CL) can check the potential variation of inclination in respect to the reference condition and, consequently, vary the motion speed (V) of the lever depending on said detected variation of inclination.

4. The device, as per claim 3, wherein said control device (CL) is connected to the sensor and programmed for calculating one or more parameters detected by the sensor indicating the inclination of the lever during the cutting and varying said motion speed consequently.

5. The device, as per claim 3, wherein the motion speed is varied in such a manner that the lever (21; 210) is brought back to said reference condition.

6. The device, as per claim 3, wherein said lever (21, 210) is constrained to a support so as to take at least a direction of inclination in respect to a constraint point (C; 220).

7. The device, as per claim 3, wherein said lever is hinged.

8. The device, as per claim 3, wherein said sensor is a HALL sensor.

9. The device, as per claim 3, wherein said sensor is an infrared sensor or an ultrasonic sensor.

10. The device, as per claim 3, wherein the control device is programmed to reduce the motion speed until said detected variation of inclination is eliminated

11. The device, as per claim 10, wherein the control device is programmed to vary the motion speed cyclically by increasing the motion speed as soon as the variation of inclination has been eliminated, and by reducing the motion speed again when the control device detects a deviation in the variation of inclination that exceeds a preset limit.

12. The device, as per claim 1, wherein the device is adapted to be integrated on a pre-existent machinery for cutting polystyrene.

13. An assembly for cutting a polystyrene block (100) by a motion of a hot wire cutter at a predetermined speed (V), comprising:
means (CL, M, S; 250, 230) that detect an inclination of a hot wire during a cut; and
a control device (CL) adapted to check a potential bending variation in respect to a reference condition and to vary motion speed (V) of the hot wire depending on a detected bending variation.

14. The assembly, as per claim 13, further comprising:
a lever (21, 210) (21; 210) adapted to be operatively coupled to the hot wire;
said lever being arranged to follow, in use, a potential inclination of the hot wire during a feed motion of the cut, said lever (21; 210) being further cooperative with a sensor (M, S; 250, 230) indicating an inclination of the lever (21; 210) while cutting, the control device (CL) being set to check said a potential variation of the inclination in respect to a reference inclination.

15. The assembly, as per claim 14, wherein the control device (CL) is programmed to vary the motion speed so as to lead back the lever (21; 210) to said reference condition.

16. The assembly, as per claim 14, wherein said lever (21, 210) is constrained to a support so as to take at least a direction of inclination in respect to a constraint point (C; 220).

17. The assembly, as per claim 14, wherein said lever is hinged.

18. The assembly, as per claim 13, wherein the control device is set to reduce the motion speed until the control unit eliminates such bending deviation.

19. The assembly, as per claim 18, wherein the control device is set to vary the motion speed cyclically by increasing the motion speed as soon as the bending deviation has been eliminated, and by reducing the motion speed again when the control device detects a deviation.

20. A machinery for cutting polystyrene comprising:
an assembly adapted to cut a polystyrene block by a motion of a hot wire cutter at a predetermined speed, the assembly comprising:
means adapted to detect an inclination of a hot wire during a cut; and
a control device adapted to check a potential variation in inclination of the hot wire from a reference condition and to vary motion speed of the hot wire depending on a detected bending variation.

21. A method of cutting of a polystyrene block (100), the method comprising:
providing a device (20, 200) having at least a lever (21; 210) adapted to be operatively coupled to at least a hot cutting element (2);
providing a control device (CL);
configuring said lever (21; 210) to detect, while cutting, a potential inclination of the hot cutting element (2), during a feed motion of the cut;
detecting said potential inclination;
checking, with the control device (CL), a potential deviation from a reference condition; and
modifying motion speed (V) of the lever depending on a detected condition.

22. The method, as per claim 21, wherein the motion speed is varied so as to bring back the hot cutting element to an initial reference condition.

23. The method, as per claim 21, wherein the motion speed is varied so as to vary the motion speed cyclically by increasing the motion speed, once a cancelling condition of the deviation has been reached, and by reducing the motion speed again when the deviation is detected.
